(19) United States
(12) Patent Application Publication
(10) Pub. No.: US 2004/0062146 A1
(43) Pub. Date: Apr. 1, 2004

(54) Speaker

(76) Inventor: Kiyoshi Yamagishi, Mie (JP)

Correspondence Address: WENDEROTH, LIND & PONACK, L.L.P., 2033 K STREET N. W., SUITE 800, WASHINGTON, DC, 20006-1021, US

(21) Appl. No.: 10/257,266

(22) PCT Filed: Aug. 6, 2001
(86) PCT No.: PCT/JP01/06730

(30) Foreign Application Priority Data
Feb. 13, 2001 (JP) 2001-034918

(51) Int. Cl. H04R 17/00

(52) U.S. Cl. 367/166

(57) ABSTRACT

A speaker comprising: a magnetic circuit provided with a through hole, and a recess formed around the through hole for retaining a magnetic fluid. The speaker further comprises a bearing provided in the through hole and a shaft supported by the bearing to be movable up and down and fixed to a center cap fixed to a voice coil. A gap between the bearing and the shaft is filled with the magnetic fluid. The speaker eliminates a damper, and realizes a very low f₀ which has not been obtained before. Furthermore, the magnetic fluid absorbs friction and resonance between the bearing and the shaft, and the magnetic fluid is kept in the recess and is supplied smoothly into the gap between the shaft and the bearing. Thus, generation of abnormal sounds is suppressed and a large amplitude operation is realized in the speakers of the present invention.

### TECHNICAL FIELD

The present invention related to a loudspeaker for use in various kinds of sound apparatus.

### BACKGROUND ART

A conventional loudspeaker (hereinafter “speaker”) technology is described referring to FIG. 7, a cross sectional view of a speaker. FIG. 8 shows a cross sectional view of another conventional speaker. A conventional speaker of FIG. 7 comprises a frame 1, a yoke 2, a magnet 3, a top plate 4, a diaphragm 9, an edge 10, a damper 11, a voice coil 12, a dust cap 14 and a magnetic gap 15. The main objective of the edge 10 is to hold the diaphragm 9 at a center portion and to close a cavity behind the diaphragm 9, while that of damper 11 is to keep the diaphragm 9 at the center and to control the lowest resonance frequency (hereinafter referred to as “f₀”) by making use of the damper's flexibility.

The higher the flexibility of damper 11, the higher the flexibility of the speaker as a whole, and the lower f₀ becomes. Since the lowest frequency a speaker can reproduce is substantially determined by f₀, specifying a flexibility for damper 11 is one of the key factors in designing the sound reproduction characteristics in a low frequency range.

As a result of expanded reproduction frequency range brought about as a result of recent progress in the digital technologies, the speakers are required to be able to reproduce still lower frequency sounds. Some of the speakers are requested to provide a low f₀ that did not exist before.

If in a conventional speaker the flexibility of the damper 11 is increased with the aim of simply lowering f₀, the capability of the damper to keep the diaphragm at the center becomes weak and a supporting state of the vibration system becomes unstable. Under such a state, the vibration system readily causes a rolling motion, which makes the voice coil 12 physically contact with yoke 2 or top plate 4 in the magnetic gap and generate abnormal noise or deteriorated sound. In the worst case, it leads to a breakdown of the voice coil 12 and vibration system.

A speaker proposed to solve the above-described problems is described referring to FIG. 8. Only the differences from the one illustrated in FIG. 7 are described. The improved speaker as shown in FIG. 8 further comprises a bearing 5, a shaft 8 and a center cap 13, besides the conventional constituent elements. The shaft 8 is fixed to the center cap 13 at the center, the center cap being fixed on the upper end of a voice coil bobbin. The shaft 8 is supported by the bearing 5 fixed in a through hole formed in a magnetic circuit. Namely, the vibration system is supported by the shaft 8, instead of the damper 11 used in the speaker of FIG. 7. An elimination of damper 11 results in an advantage that is equivalent to an extremely flexible damper 11, while the centering of the vibration system is well maintained.

In the conventional speaker as shown in FIG. 8, however, there exists friction between the shaft 8 and the bearing 5, and resonance occurs in a gap between the shaft 8 and the bearing 5. The resonance is transferred via shaft 8 to the diaphragm 9, and magnified to cause an abnormal sound. In order to prevent such drawbacks, a countermeasure, for example, inserting a sound absorbing material between the shaft 8 and the diaphragm 9, needs to be provided. However, the countermeasure impairs rigid supporting of the shaft 8; more importantly, it cannot prevent generation of abnormal sounds completely.

The present invention addresses the drawbacks of the conventional speakers, and aims to provide a speaker in which an abnormal sound is suppressed and the vibration system can move at great amplitudes.

### DISCLOSURE OF THE INVENTION

A speaker of the present invention comprises a through hole provided in a magnetic circuit, and a recess formed around the through hole for preserving a magnetic fluid. The speaker of the present invention further comprises a bearing disposed in the through hole, and a shaft fixed to a center cap which is fixed to a voice coil, the shaft being supported by the bearing to be movable up and down in the bearing. A gap between the bearing and the shaft is filled with a magnetic fluid.

The speaker in which damper has a damper has eliminated, is equivalent to a speaker that has a damper of extremely high flexibility. So, the speaker realizes a low f₀ that could not be obtained before. Further, the magnetic fluid absorbs friction and resonance generated between the bearing and the shaft, and the recess contains the magnetic fluid to ensure a continuous supply to the gap between the shaft and the bearing. Therefore, the speaker suppresses generation of abnormal sounds and allows the vibration system to move in great amplitudes.

In a speaker in claim 2 of the present invention, the yoke is provided with a recess formed adjacent to a through hole in a surface at the magnet side. With this configuration, a bearing length in a top plate can be determined without restriction so that the shaft is supported in a stable manner with respect to the direction of thrust motion.

In a speaker in claim 3 of the present invention, the top plate is provided with a recess formed nearby a through hole in a surface at the magnet side. With this configuration, a magnetic fluid is kept in a location adjacent to a bearing so that the magnetic fluid is smoothly supplied to the bearing.

A speaker in claim 4 of the present invention is further provided with a damper in addition to the above-described structures of the present invention. This configuration prevents a leap phenomenon at great amplitudes and improves symmetrical vibration between the up-side and down-side amplitudes, which drawbacks are beyond the control of a combination of only the shaft and the bearing, although the configuration might be slightly inferior in flexibility to a speaker with no damper.

A speaker in claim 5 of the present invention is further provided with a bearing cover disposed around the through hole on the upper surface of the top plate. This configuration prevents the magnetic fluid from spreading over a surface of magnetic circuit and sneaking into the magnetic gap.

In a speaker in claim 7 of the present invention, the bearing for supporting the shaft is provided with a bearing portion whose inner diameter is larger than the diameter of a shaft. In this configuration, the bearing portion having a larger inner diameter is used for preserving the magnetic fluid. So, the magnetic fluid can be delivered to the bearing in a more stable manner. Thus, a length of the bearing which supports the shaft can be made shorter to reduce frictional resistance with the shaft, while maintaining enough overall length for rigidly holding the bearing in an external structure.

### BRIEF DESCRIPTION OF THE DRAWINGS

FIG. 1 is a cross-sectional view of a speaker in accordance with an exemplary embodiment of the present invention.

FIG. 2 is a cross-sectional view of a speaker in a modified example.

FIG. 3 is a cross-sectional view of a speaker in accordance with another exemplary embodiment of the present invention.

FIG. 4 is a characteristics chart showing an input sine wave frequency versus a maximum value in up-and-down amplitudes of the speaker.

FIG. 5 is a cross-sectional view of a speaker in accordance with still another exemplary embodiment of the present invention.

FIG. 6 is a cross-sectional view of a bearing, which is a key part of the speaker.

FIG. 7 is a cross-sectional view of a conventional speaker.

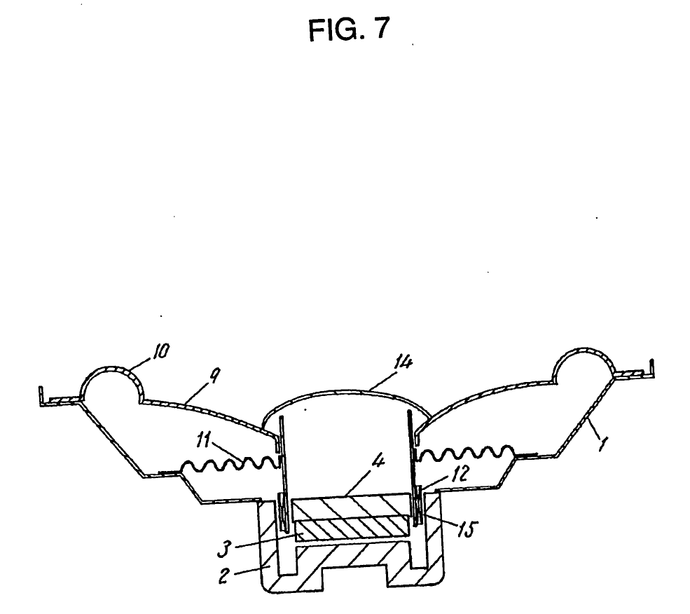

FIG. 8 is a cross-sectional view of an improved conventional speaker.

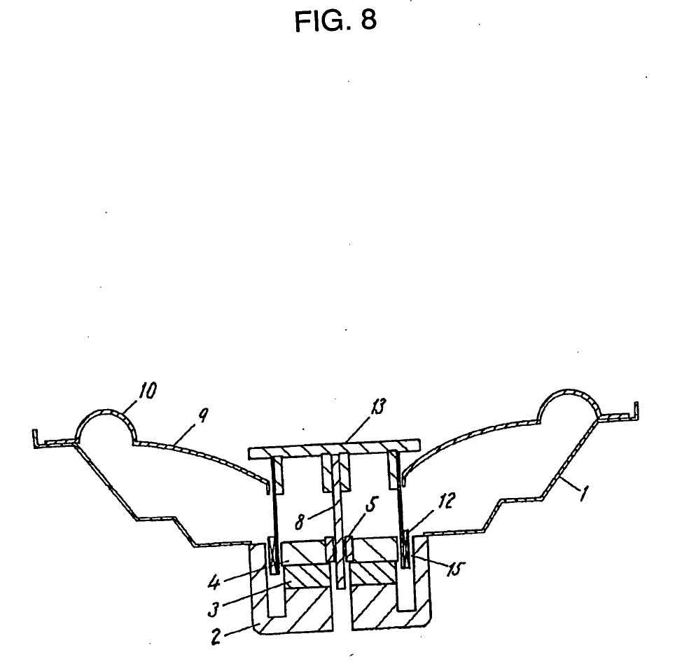

### BEST MODE FOR CARRYING OUT THE INVENTION

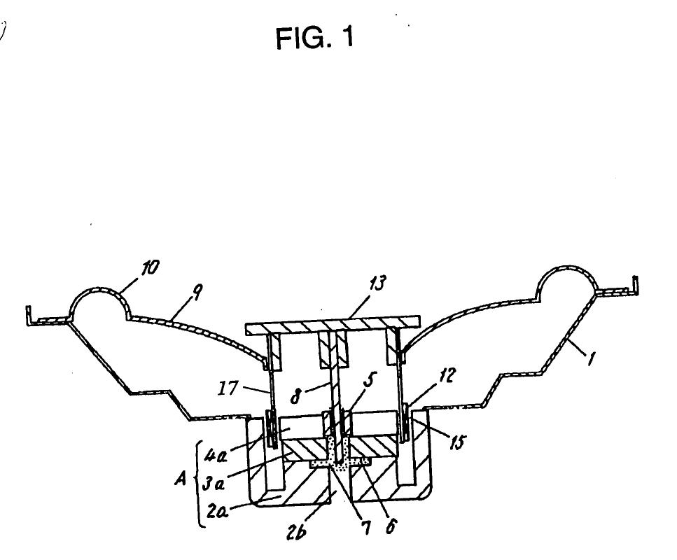

Speakers in accordance with exemplary embodiments of the present invention are described referring to drawing FIG. 1 through FIG. 6. Those parts identical to those in the conventional technology are represented by using the same reference numerals, and description of such parts is omitted.

First Embodiment

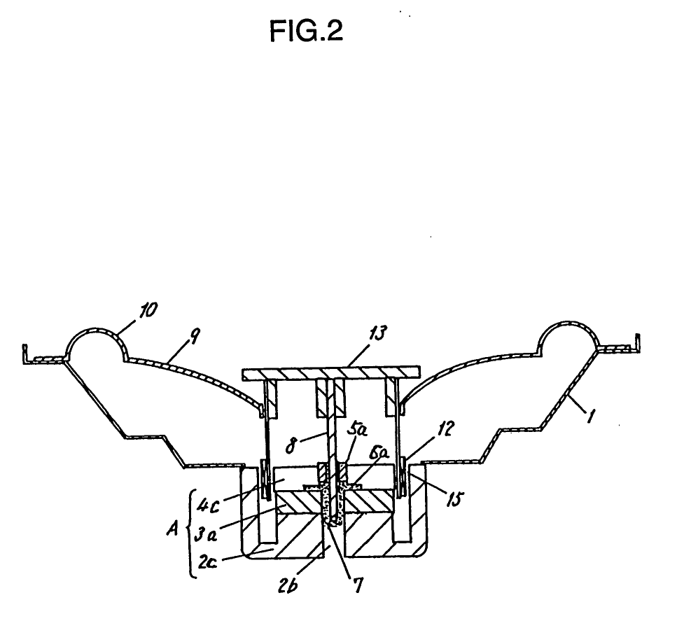

A speaker in accordance with an exemplary embodiment of the present invention is described referring to FIG. 1 and FIG. 2. Descriptions of the present embodiment are relevant mainly to claim 1, claim 2 and claim 3 of the present invention.

In a speaker of the present invention, an inner magnet type magnetic circuit A is formed of a yoke 2a, a magnet 3a and a top plate 4a, and the magnetic circuit is provided with a through hole 2b at the center, as shown in FIG. 1. A frame 1 is fixed on the yoke 2a of magnetic circuit A. A diaphragm 9 and an edge 10 are fixed on the frame 1. A bobbin 17 of a voice coil 12 is fixed to an inner circumference of the diaphragm 9, and the voice coil 12 is supported in a magnetic gap 15 formed by the yoke 2a and the top plate 4a. A center cap 13 is fixed on the bobbin 17 at the top edge, so as to be coaxial with the axis of the bobbin 17.

A bearing 5 is fixed to be coaxial with the axis of the through hole 2b. A shaft 8 is fixed at the top end to a center of the center cap 13, and supported by the bearing 5 so that it can move up and down.

The yoke 2a is provided, in its surface making contact with the magnet 3a, with a recess 6 formed around the through hole 2b. The diameter of the recess 6 is larger than that of the through hole 2b. Since the recess 6 is a gap formed in a field of a magnetic circuit, the density of magnetic flux at recess 6 is higher than that in the rest of the through hole 2b. Therefore, a magnetic fluid 7 injected in the vicinity of the bearing 5 is kept in the recess 6; it does not escape through the through hole 2b. The magnetic fluid 7 is thus preserved in the recess 6 to be continuously supplied to the gap formed between the bearing 5 and the shaft 8 accompanied by the up and down motion of the shaft 8.

The recess may be provided by spot facing the yoke material around the center of the through hole, or by pressing the yoke material simultaneously when forming the yoke, or by a separate pressing process. It is easiest to provide a recess in a round shape from the view point of the machining process. However, the shape of the recess is not limited to a round shape.

In the present embodiment, since the recess 6 is formed in a surface of the yoke 2 at a magnet side, a length of the bearing 5 in the top plate 4a can be any desired length.

FIG. 2 shows a speaker in a modified example of the present embodiment. In this speaker a recess 6a is provided around a through hole 2b in the top plate 4c on the surface at the magnet 3a side.

By appropriately adjusting the length of a bearing 5a so that it does not block the recess 6a, as illustrated in FIG. 2, the magnetic fluid 7 can be preserved in a location adjacent to the bearing 5a. With this configuration, the magnetic fluid 7 is supplied to the bearing 5a smoothly.

With the above-configured speaker having a 12 cm diameter, for example, it has been confirmed that an f₀ of lower than 30 Hz can be obtained, whereas with a conventional speaker the f₀ is approximately 60 Hz at its lowest. Also the friction sound and the resonance sound caused by the bearing 5a and the shaft 8 are completely eliminated in the speaker of the present invention. Thus a speaker which exhibits a stable performance even at great amplitudes is provided.

Second Embodiment

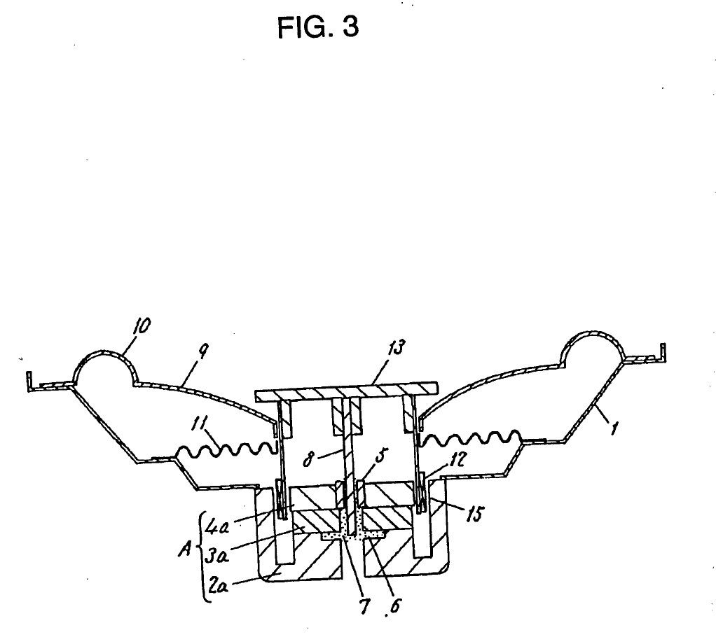

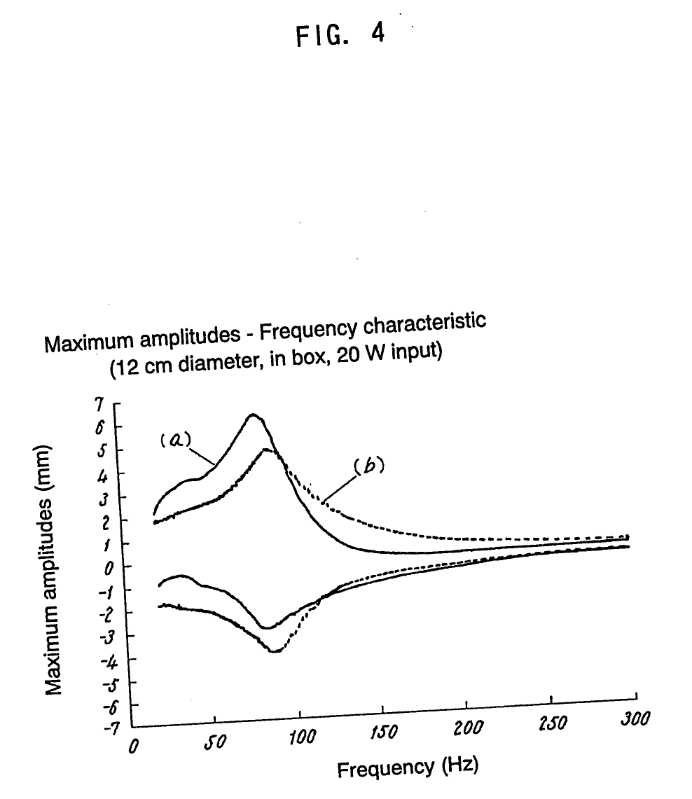

A speaker in accordance with a second exemplary embodiment of the present invention is described referring to FIG. 3 and FIG. 4. Description is made focusing on a point of difference from the first embodiment.

The description here is relevant mainly to claim 4 of the present invention.

FIG. 3 is a cross-sectional view of a speaker in the present embodiment, while FIG. 4 is a characteristics chart showing a relation between maximum amplitudes and frequency characteristics. As FIG. 3 shows, the speaker of the present embodiment is provided with a damper 11, which is fixed at the outer circumference to the frame 1 and at the inner circumference to the voice coil 12. In the speaker of the first embodiment, where a damper is eliminated, the vibration system is provided with full flexibility; however, the up and down motion is not controlled until the edge 10 is expanded to its full length. So, a leap phenomenon or a distortion due to asymmetry among the up-side and down-side amplitudes can readily occur. The configuration in the present embodiment addresses the above drawbacks, and aims to provide a speaker which operates in a more stable manner with a lower distortion.

A preferred property of the damper 11 here is a high amplitude linearity during normal operation, while it gradually suppresses the amplitudes when a large input that moves the voice coil 12 out of magnetic gap 15 is applied. Since the damper 11 in the present embodiment is not expected to function to keep a vibration system at a center, it is easy to provide the damper with high flexibility for maintaining the f₀ at a low level.

A 12 cm diameter speaker in the present embodiment 2 is mounted in a box to be measured with respect to “input sine wave frequency” versus “maximum up-down amplitudes”, and the results are shown in FIG. 4. In FIG. 4, a curve (a) represents a speaker in the first embodiment, while a curve (b) represents a speaker in present embodiment 2. As seen in FIG. 4, the curve (b) shows a stable change in amplitude and a significantly improved symmetry among the up and down amplitudes, as compared with the curve (a), or characteristics in the first embodiment. Thus the advantage of the present embodiment 2 has been confirmed.

Third Embodiment

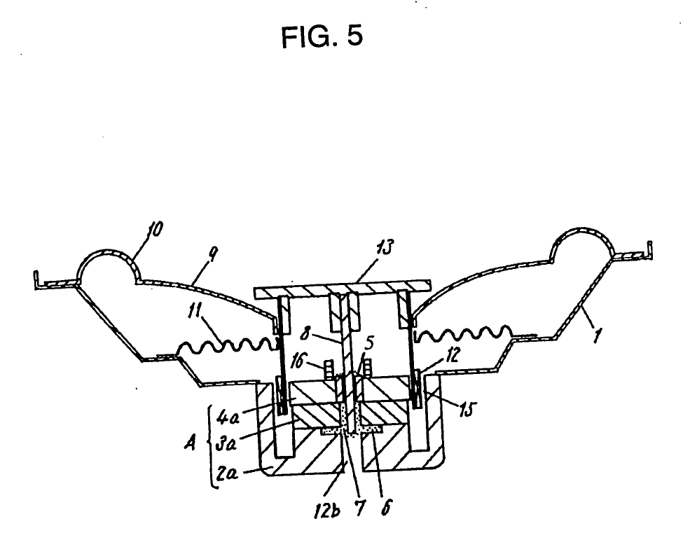

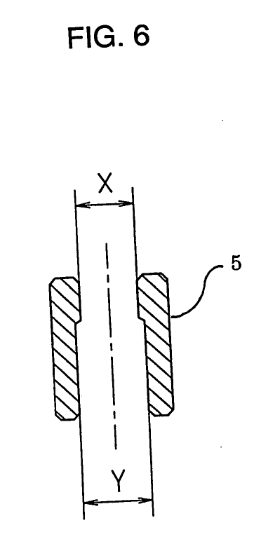

FIG. 5 is a cross-sectional view of a speaker in accordance with a third exemplary embodiment of the present invention. FIG. 6 shows a cross-sectional view of the key part, or a bearing. In the following, the differences from the first and the second embodiments are described. The description of the present embodiment 3 is relevant mainly to claim 5 and claim 6 of the present invention.

As shown in FIG. 5, the difference from the first embodiment is that a speaker in the present embodiment 3 is provided with a bearing cover 16 surrounding the bearing 5, which is disposed on the upper surface of the top plate 4a in a location around the through hole 12b. In case magnetic fluid 7 is pushed out from the top end of bearing 5, it might be pulled into the magnetic gap 15 if the bearing cover 16 is not provided. If the magnetic fluid 7 is pulled into the magnetic gap 15 in volume, it would clog the magnetic gap 15 to generate abnormal sound. Or, the gap between bearing 5 and shaft 8 might be short of magnetic fluid 7, which also would cause abnormal sound. The present embodiment addresses the above problems and aims to improve the reliability, by blocking outgoing flow of the magnetic fluid 7 with the bearing cover 16.

Since the flow of magnetic fluid 7 blocked by bearing cover 16 is always under the influence of a horizontal pulling force of magnetic gap 15, the magnetic fluid 7 is preserved inside the bearing cover 16 on the bottom and part of it is delivered again into the bearing 5 as a result of up and down motion of shaft 8. Therefore, a preferred height of the bearing cover 16 is 1 mm or higher. Preferred material for the bearing cover 16 is a non-magnetic material, in view of leakage of the magnetic flux and the ease of assembly.

As described above, a speaker in the present embodiment is provided with a double safety means against a possible outflow of magnetic fluid 7; namely, the bearing cover 16 in addition to the recess 6 having a high magnetic flux density. Thus additional reliability is provided in the present embodiment.

Furthermore, the bearing 5 is formed to have a portion whose inner diameter is X, and another portion whose inner diameter is Y which is larger than X, as illustrated in FIG. 6. The portion having inner diameter X supports the shaft 8, while the other portion having inner diameter Y provides a certain appropriate gap against shaft 8. Thus, the length of bearing which supports a shaft can be made shorter to reduced frictional resistance with the shaft 8, while maintaining overall length sufficient for rigidly mounting a bearing 5 in an external structure.

Still further, the portion of inner diameter Y containing the magnetic fluid 7 contributes to a smoother supply of the magnetic fluid 7 to the bearing.

According to experimental results, an appropriate difference between the inner diameter X and the inner diameter Y is 0.1 mm-0.5 mm.

### INDUSTRIAL APPLICABILITY

In a speaker of the present invention, a shaft supported to be movable in up and down directions by a bearing holds the voice coil via a center cap, and a magnetic fluid is supplied between the bearing and the shaft. The speaker having the above-described configuration provides a low f₀, and operates with stable performance without any accompanying abnormal sound. Thus the present invention provides a speaker which radiates sound of improved quality, in which a reproduction frequency of a low frequency range sound has been expanded and distortion is reduced.

What is claimed is:

1. A speaker comprising:
a magnetic circuit provided with a magnetic gap, a through hole and a recess surrounding said through hole;
a frame fixed on said magnetic circuit;
a diaphragm fixed at an outer circumference to said frame,
a voice coil supported in said magnetic gap,
a center cap fixed on a top end of a voice coil bobbin fixed to said diaphragm,
a bearing fixed in said through hole,
a shaft supported by said bearing so that it can move up and down, said shaft being fixed to said center cap, and
a magnetic fluid filled around said shaft.

2. The speaker of claim 1, wherein said magnetic circuit comprises a yoke, a magnet and a top plate, said yoke being provided with the recess formed in the surface at said magnet side.

3. The speaker of claim 1, wherein said magnetic circuit comprises a yoke, a magnet and a top plate, said top plate being provided with the recess in the surface at said magnet side.

4. The speaker of any one of claims 1 through 3, further comprising a damper fixed at an inner circumference to said voice coil bobbin, at an outer circumference to said frame.

5. The speaker of any one of claims 1 through 3, wherein said top plate is provided with a bearing cover disposed around the through hole.

6. The speaker of claim 4, wherein said top plate is provided with a bearing cover disposed around the through hole.

7. The speaker of any one of claims 1 through 3, wherein said bearing is provided with an inner diameter for supporting said shaft, and another inner diameter larger than said inner diameter.

8. The speaker of claim 4, wherein said bearing is provided with an inner diameter for supporting said shaft, and another inner diameter larger than said inner diameter.

9. The speaker of claim 5, wherein said bearing is provided with an inner diameter for supporting said shaft, and another inner diameter larger than said inner diameter.

10. The speaker of claim 7, wherein said bearing is provided with an inner diameter for supporting said shaft, and another inner diameter larger than said inner diameter.
